(19) United States
(12) Patent Application Publication
(10) Pub. No.: US 2014/0273659 A1
(43) Pub. Date: Sep. 18, 2014

(54) Terminal With Front End Protection

(71) Applicant: LEAR CORPORATION, Southfield, MI (US)

(72) Inventors: Michael Glick, Farmington Hills, MI (US); Slobodan Pavlovic, Novi, MI (US); Tulasi Sadras-Ravindra, Canton, MI (US)

(73) Assignee: LEAR CORPORATION, Southfield, MI (US)

(21) Appl. No.: 14/168,068

(22) Filed: Jan. 30, 2014

Related U.S. Application Data
(60) Provisional application No. 61/786,726, filed on Mar. 15, 2013.

(51) Int. Cl. H01R 24/60

(52) U.S. Cl. CPC H01R 24/60
USPC 439/676

(57) ABSTRACT

An electric terminal includes a conductive portion with a base and a plurality of contact arms extending therefrom. The electric terminal includes a protective shroud that extends farther from the base than the contact arms do.

### CROSS-REFERENCE TO RELATED APPLICATIONS

This application claims the benefit of U.S. Provisional Application No. 61/786,726, filed Mar. 15, 2013, the disclosure of which is incorporated herein by reference.

### BACKGROUND OF THE INVENTION

This invention relates in general to an electric terminal. More particularly, this invention relates to an electric terminal that includes features to protect the conductive components of the terminal from damage.

Electric terminals are commonly used to create an electric connection between electric components, for example to connect a component to a power source. A pair of complementary electric terminals includes two electrically-conductive components that are brought into engagement with each other. Damage to one of the electrically-conductive components can impair the ability of the terminal to provide an adequate electric connection. Therefore, care must be taken not to damage either of the electrically-conductive components. It would be desirable to have an electric terminal that helps prevent damage to the electrically-conductive components.

### SUMMARY OF THE INVENTION

This invention relates to an electric terminal. The electric terminal includes a conductive portion with a base and a plurality of contact arms extending therefrom. The electric terminal includes a protective shroud that extends farther from the base than the contact arms do.

This invention further relates to an electric terminal. The electric terminal includes a conductive portion that has a base and a plurality of contact arms extending therefrom. The electric terminal has a spring portion made of an electrically conductive material. The spring portion is configured to bias at least one of the plurality of contact arms in an inward direction. The spring portion includes a protective shroud that extends farther from the base than the contact arms do.

This invention further relates to an electric terminal. The electric terminal includes a conductive portion with a base and a plurality of contact arms extending therefrom. The electric terminal includes a spring portion made of an electrically conductive material. The spring portion is configured to bias at least one of the plurality of contact arms in an inward direction. The spring portion includes a protective shroud that extends farther from the base than the contact arms do. There is at least one projection on the protective shroud. The protective shroud defines a shroud opening. The shroud opening is configured so that a second terminal that mates with the plurality of contact arms of the electric terminal will pass through the shroud opening. The at least one projection on the protective shroud narrows the size of the shroud opening.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an electric terminal including an end protection.

FIG. 2 is a bottom view of the electric terminal shown in FIG. 1.

FIG. 3 is a perspective view of an alternative electric terminal that includes an alternative end protection.

FIG. 4 is a side view of the alternative electric terminal shown in FIG. 3.

FIG. 5 is a perspective view on a second alternative electric terminal that includes a second alternative end protection.

FIG. 6 is a side view of the second alternative electric terminal shown in FIG. 5.

### DETAILED DESCRIPTION OF THE PREFERRED EMBODIMENT

Referring now to the drawings, there is illustrated in FIG. 1 an electric terminal indicated generally at 10. The illustrated terminal 10 includes two components that are made of two different materials: A conductive portion 12 and a spring portion 14. The terminal 10 is a female terminal, and is designed to mate with a complementary second terminal, male blade terminal 16, in order to establish an electric connection between the terminal 10 and the blade terminal 16. The conductive portion 12 is configured to engage the blade terminal 16 when the blade terminal 16 is mated with the terminal 10, and is made of a material selected for its desired electrically conductive characteristics, such as, for example, copper, aluminum, an alloy of one of these metals, or any other desired electrically conductive material. The spring portion 14 is configured to bias the conductive portion 12 into contact with the blade terminal 16 when the blade terminal 16 is mated with the terminal 10, and is made of a material selected for its desired resilient characteristics, such as stainless steel. The spring portion 14 may also be selected for its electrical conductive characteristics. In the illustrated embodiment, when the terminal 10 is mated with the blade terminal 16 and used to transfer electric current, the conductive portion 12 is primarily designed to conduct current while the spring portion 14 is primarily designed to help maintain contact between the conductive portion 12 and the blade terminal 16; however, the illustrated spring portion 14 also is able to conduct electric current. It should be appreciated that the illustrated terminal 10 is only one embodiment, and the terminal 10 may have a different design from that shown, if desired, and may be made of different materials from those described, if desired. Further, it should be appreciated that the spring portion 14 may be made of the same material as the conductive portion 12, if desired. The electric terminal 10 is similar to the female terminal receptor taught in U.S. Pat. No. 7,892,050, the disclosure of which is hereby incorporated by reference.

The conductive portion 12 includes a base 18 and an attached, generally rectangular box 20. Contact arms, indicated generally at 22, extend from the box 20. The conductive portion 12 may be stamped from a single piece of electrically conductive material and folded into the shape shown. Alternatively, the conductive portion may be made in any other desired manner. Further, the conductive portion 12 may have a different shape from that illustrated, if desired. The illustrated conductive portion 12 includes eight contact arms 22a through 22h. A first set of contact arms, 22a through 22d, extends from a first side 24 of the box 20, while a second set of contact arms, 22e through 22h, extends from a second side 26 of the box 20. The first set of contact arms 22a-22d and the second set of contact arms 22e-22h are biased toward each other. When the blade terminal 16 is mated with the electric terminal 10, it is inserted between the first set of conductive arms 22a-22d and the second set of conductive arms 22e-22h, and the two sets of contact arms are pushed apart.

The spring portion 14 helps bias first set of contact arms 22a-22d and the second set of contact arms 22e-22h toward each other. As previously described, the spring portion 14 is made of a material such as stainless steel that has improved resilient characteristics as compared to the conductive portion 12. The spring portion includes a first cross member 30 located on the first side 24 of the box 20, and a second cross member 32 located on the second side 26 of the box 20. A pair of spring bases 34 extends through the box 20 and connects the first cross member 30 and the second cross member 32. The spring portion 14 includes four spring arms 36a through 36d. The spring arms 36a-36b extend from the first cross member 30 generally adjacent to the first set of contact arms 22a-22d, and the spring arms 36c-36d extend from the second cross member 32 generally adjacent to the second set of contact arms 22e-22h. Spring arm 36a includes a guide 38a that serves to align spring arm 36a with contact arm 22a and contact arm 22b. Spring arm 36a helps bias contact arm 22a and contact arm 22b in inward directions. Similarly, each of the spring arms 36b-36d engages two of the contact arms 22 and helps bias the respective contact arms in the inward direction. It should be appreciated that the inward direction is toward a line 37 shown on FIG. 1. The line 37 is located between the first set of contact arms 22a-22d and the second set of contact arms 22e-22h. By biasing the contact arms 22 in the inward direction, the spring member 14 biases the contact arms 22 into engagement with the blade terminal 16 when it is mated with the electric terminal 10. It should also be appreciated that the illustrated spring portion 14 is only one, non-limiting embodiment, and the spring member may have a design other than that shown, if desired.

If the contact arms 22 are damaged the electric terminal 10 may not establish a satisfactory electric connection with the blade terminal 16. For example, if one or more of the contact arms 22 is bent from its proper position it may not properly engage the blade terminal 16. The contact arms 22 could be damaged by a side-impact, or the contact arms 22 could be damaged when the electric terminal 10 is improperly mated with the blade terminal 16, for example if the two components are not properly aligned. If the blade terminal 10 is improperly aligned with the contact arms 22, the blade terminal 16 may be improperly pressed against an outer end 28 of one or more of the contact arms 22 and this could undesirably bend one or more of the contact arms 22.

In order to help protect the contact arms 22 from damage, the electric terminal 10 includes a protective shroud 40. The protective shroud 40 is connected to the second cross member 32 of the spring portion 14 by a pair of side walls 42. The protective side walls 42 and the protective shroud 40 are stamped as one piece as part of the spring portion 14. However, the protective shroud 40 and the side walls 42 may be separate components, if desired. As best seen in FIG. 2, the protective shroud 40 extends farther from the box 20 than the contact arms 22 do and there is a space 41 between an outer end 43 of the protective shroud 40 and the outer end 28 of the contact arms 22. As shown in FIG. 1, the protective shroud 40 and the side walls 42 help protect the contact arms 22 from being struck from a side direction 44, or a front direction 46. Thus, the protective shroud 40 provides side protection and front end protection for the electric terminal 10. Additionally, the protective shroud 40 defines a shroud opening 48. When the blade terminal 16 is mated with the electric terminal 10, it is passed through the shroud opening 48. Thus, the shroud opening 48 serves to limit the amount of potential misalignment between the blade terminal 16 and the electric terminal 10. Thus, the protective shroud 40 helps to assure that the blade terminal 16 is properly aligned with the contact arms 22 when the blade terminal 16 is mated with the electric terminal 10. This helps to limit the potential for the contact arms 22 to be damaged during mating of the electric terminal 10 and the blade terminal 16.

Referring now to FIG. 3, there is illustrated an alternative electric terminal, indicated generally at 110. The alternative electric terminal 110 includes many components similar to those in the electric terminal 10, and similar components are identified with a similar number but with a 100 prefix. However, it should be appreciated that the features of the alternative electric terminal 110 may be different from those illustrated, if desired.

The alternative electric terminal 110 includes a spring portion 114 with a protective shroud 140 and side walls 142. The side walls 142 include optional narrowed portions 150 that define openings or windows 152. As can be seen in a comparison between FIG. 3 and FIG. 1, the windows 152 increase the visibility of outer ends 128 of contact arms 122. This makes it easier for a user to properly align a blade terminal 116 with the contact arms 122 when the blade terminal 116 is mated with the alternative electric terminal 110. The illustrated narrow portion 150 is located in the center of the side wall 142, and defines two equally-sized windows 152. However, the side wall 142 may include different sized windows, or a different number of windows, if desired.

The spring portion 114 also includes optional rearward guides 154. The rearward guides 154 are projections on the protective shroud 140 that extend from the protective shroud 140 toward the contact arms 122. The rearward guides 154 are arranged in opposed pairs, one rearward guide of each pair on a first side 124 of the alternative electric terminal 110 and the other rearward guide on a second side 126 of the alternative electric terminal 110. The members of each pair of rearward guides 154 are closer to each other at distal ends 156 than they are at the protective shroud 140. Thus, the rearward guides 154 serve to narrow the effective size of a shroud opening 148. When the blade terminal 116 is mated with the alternative electric terminal 110, it is passed through the shroud opening 148. Thus, the rearward guides 154 serve to further limit the amount of potential misalignment between the blade terminal 116 and the alternative electric terminal 110.

Referring now to FIG. 5, there is illustrated a second alternative electric terminal, indicated generally at 210. The alternative electric terminal 210 includes many components similar to the electric terminal 10, and similar components are identified with a similar number but with a 200 prefix. However, it should be appreciated that the features of the second alternative electric terminal 210 may be different from those illustrated, if desired.

The second alternative electric terminal 210 includes a spring portion 214 with optional forward guides 258. The forward guides 258 are projections on a protective shroud 240 that extend from the protective shroud 240 away from contact arms 222 (to the right as viewed in FIG. 5). The forward guides 258 are arranged with one on a first side 224 of the second alternative electric terminal 210 and the other on a second side 226 of the second alternative electric terminal 210. The forward guides 258 are closer to each other at distal ends 260 than they are at the protective shroud 240. Thus, the forward guides 258 serve to narrow the effective size of a shroud opening 248. When a blade terminal 216 is mated with the second alternative electric terminal 210, it is passed through the shroud opening 248. Thus, the forward guides 258 serve to further limit the amount of potential misalignment between the blade terminal 216 and the second alternative electric terminal 210.

Although not shown in the illustrated embodiment, it should be appreciated that the spring member 214 of the second alternative electric terminal 210 may include windows similar to the windows 152 shown on the alternative electric terminal 110 above, if desired.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An electric terminal comprising:
a conductive portion including a base and a plurality of electrically-conductive contact arms extending therefrom; and
a protective shroud that extends farther from the base than the contact arms do.

2. The electric terminal of claim 1, further comprising a spring portion configured to bias at least one of the plurality of contact arms in an inward direction;
wherein the protective shroud is connected to the spring portion by a side wall.

3. The electric terminal of claim 2, wherein the protective shroud is part of the spring portion.

4. The electric terminal of claim 3, wherein the side wall includes at least one narrowed portion that defines a window.

5. The electric terminal of claim 4, wherein the protective shroud defines a shroud opening configured so that a second terminal that mates with the plurality of contact arms of the electric terminal will pass through the shroud opening.

6. The electric terminal of claim 5, further comprising at least one projection on the protective shroud that narrows the size of the shroud opening.

7. The electric terminal of claim 6, wherein the projection extends from the protective shroud toward the contact arms.

8. The electric terminal of claim 6, wherein the projection extends from the protective shroud away from the contact arms.

9. The electric terminal of claim 3, wherein the spring portion is made of an electrically conductive material.

10. The electric terminal of claim 9, wherein the spring portion is made of a different material than the conductive portion.

11. The electric terminal of claim 10, wherein the protective shroud defines a shroud opening configured so that a second terminal that mates with the plurality of contact arms of the electric terminal will pass through the shroud opening.

12. The electric terminal of claim 11, further comprising at least one projection on the protective shroud that narrows the size of the shroud opening.

13. The electric terminal of claim 12, wherein the projection extends from the protective shroud toward the contact arms.

14. The electric terminal of claim 13, wherein the projection extends from the protective shroud away from the contact arms.

15. An electric terminal comprising:
a conductive portion including a base and a plurality of contact arms extending therefrom; and
a spring portion made of an electrically conductive material and configured to bias at least one of the plurality of contact arms in an inward direction, the spring portion including a protective shroud that extends farther from the base than the contact arms do.

16. The electric terminal of claim 15, wherein the protective shroud defines a shroud opening configured so that a second terminal that mates with the plurality of contact arms of the electric terminal will pass through the shroud opening.

17. The electric terminal of claim 16, further comprising at least one projection on the protective shroud that narrows the size of the shroud opening.

18. The electric terminal of claim 17, wherein the projection extends from the protective shroud toward the contact arms.

19. The electric terminal of claim 17, wherein the projection extends from the protective shroud away from the contact arms.

20. An electric terminal comprising:
a conductive portion including a base and a plurality of contact arms extending therefrom; and
a spring portion made of an electrically conductive material and configured to bias at least one of the plurality of contact arms in an inward direction, the spring portion including a protective shroud that extends farther from the base than the contact arms do, and at least one projection on the protective shroud;
wherein the protective shroud defines a shroud opening configured so that a second terminal that mates with the plurality of contact arms of the electric terminal will pass through the shroud opening and that the at least one projection on the protective shroud narrows the size of the shroud opening.
